(19) United States
(12) Patent Application Publication
(10) Pub. No.: US 2026/0040293 A1
(43) Pub. Date: Feb. 5, 2026

(54) SYSTEMS AND METHODS FOR DATA COLLECTION FOR BEAMFORMED SYSTEMS

(71) Applicant: Telefonaktiebolaget LM Ericsson (PUBL), Stockholm (SE)

(72) Inventors: Mattias FRENNE, UPPSALA (SE); Andreas NILSSON, GÖTEBORG (SE)

(21) Appl. No.: 19/103,311

(22) PCT Filed: Aug. 11, 2023
(86) PCT No.: PCT/IB2023/058144

§ 371 Date: Feb. 12, 2025

Related U.S. Application Data
(60) Provisional application No. 63/397,429, filed on Aug. 12, 2022.

(51) Int. Cl. H04W 72/044; H04L 5/00; H04W 24/08; H04W 72/232

(52) U.S. Cl. CPC H04W 72/046; H04L 5/0094; H04W 24/08; H04W 72/232

(57) ABSTRACT

A method (900) by a first user equipment, UE (108, 110), for data collection includes receiving (902), from a network node (104), a first message configuring one or more downlink reference signal resources. The UE receives (904), from the network node, a second message comprising an indication to monitor a communication channel associated with a radio network temporary identifier, RNTI, for data collection. The UE receives (906) a third message comprising downlink control information, DCI, associated with the RNTI for data collection. The third message indicates to the UE to perform measurements on one or more of the downlink reference signal resources. Based on the third message comprising the DCI associated with the RNTI for data collection, the UE performs (908) at least one measurement on a downlink reference signal transmitted for a second UE (106). The downlink reference signal is transmitted on one of the one or more indicated downlink reference signal resources.

### TECHNICAL FIELD

The present disclosure relates, in general, to wireless communications and, more particularly, systems and methods for data collection for beamformed systems.

### BACKGROUND

Artificial Intelligence (AI) and Machine Learning (ML) have been investigated, both in academia and industry, as promising tools to optimize the design of the air-interface in wireless communication networks. Example use cases include using autoencoders for Channel State Information (CSI) compression to reduce the feedback overhead and improve channel prediction accuracy; using deep neural networks for classifying Line-of-Sight (LOS) and Non-LOS (NLOS) conditions to enhance the positioning accuracy; and using reinforcement learning for beam selection at the network side and/or the User Equipment (UE) side to reduce the signaling overhead and beam alignment latency; using deep reinforcement learning to learn an optimal precoding policy for complex Multiple Input Multiple Output (MIMO) precoding problems.

In 3rd Generation Partnership Project (3GPP) New Radio (NR) standardization work, there is a new Release 18 study item on AI/ML for the NR air interface. This study item explores the benefits of augmenting the air-interface with features enabling improved support of AI/ML based algorithms for enhanced performance and/or reduced complexity/overhead. Through studying a few selected use cases (e.g., CSI feedback, beam management, and positioning), this study item aims at laying the foundation for future air-interface use cases leveraging AI/ML techniques.

### Beam Management Procedure

In high frequency range (FR2), multiple radio frequency (RF) beams may be used to transmit and receive signals at a gNodeB (gNB) and a UE. For each downlink (DL) beam from a gNB, there is typically an associated best UE received (Rx) beam for receiving signals from the DL beam. The DL beam and the associated UE Rx beam form a beam pair. The beam pair can be identified through a so-called beam management process in NR.

A DL beam is typically identified by an associated DL reference signal (RS) transmitted in the beam, either periodically, semi-persistently, or aperiodically. The DL RS for the purpose can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of DL-RS in the reported best DL beam to let the UE evaluate candidate UE RX beams.

Although not explicitly stated in the NR specification, beam management has been divided into three procedures, schematically illustrated in FIG. 1:
P-1: Purpose is to find a coarse direction for the UE using wide gNB TX beam covering the whole angular sector
P-2: Purpose is to refine the gNB TX beam by doing a new beam search around the coarse direction found in P1.
P-3: Used for UE that has analog beamforming to let them find a suitable UE RX beam.
P-1 is expected to utilize beams with rather large beamwidths and where the beam reference signals are transmitted periodically and are shared between all UEs of the cell. Typically reference signal to use for P-1 are periodic CSI-RS or SSB. The UE then reports the N best beams to the gNB and their corresponding Reference Signal Received Power (RSRP) values.
P-2 is expected to use aperiodic/or semi-persistent CSI-RS transmitted in narrow beams around the coarse direction found in P-1.
P-3 is expected to use aperiodic or semi-persistent CSI-RSs repeatedly transmitted in one narrow gNB beam. One alternative way is to let the UE determine a suitable UE RX beam based on the periodic SSB transmission. Since each SSB consists of four Orthogonal Frequency Division Multiplexing (OFDM) symbols, a maximum of four UE RX beams can be evaluated during each SSB burst transmission. One benefit with using SSB instead of CSI-RS is that no extra overhead of CSI-RS transmission is needed.

### Beam Indication

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the Physical Downlink Shared Channel (PDSCH) Demodulation Reference Signal (DMRS). When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to receive also this signal.

In NR, the spatial QCL relation for a DL or uplink (UL) signal/channel can be indicated to the UE by using a “beam indication”. The “beam indication” is used to help the UE to find a suitable RX beam for DL reception, and/or a suitable TX beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Rel-15/16) or a TCI state (in NR rel-17).

### Beam Management with Unified TCI Framework

In NR, downlink beam management is performed by conveying spatial QCL (‘Type D’) assumptions to the UE through TCI states.

In NR Rel-15 or Rel-16, for Physical Downlink Control Channel (PDCCH), the network configures the UE with a set of PDCCH TCI states by Radio Resource Control (RRC), and then activates one TCI state per CORESET using Medium Access Control-Control Element (MAC CE). For PDSCH beam management, the network configures the UE with a set of PDSCH TCI states by RRC, and then activates up to 8 TCI states by MAC CE. After activation, the network dynamically indicates one of these activated TCI states using a TCI field in Downlink Control Information (DCI) when scheduling PDSCH.

Such a framework allows great flexibility for the network to instruct the UE to receive signals from different spatial directions in DL with a cost of large signaling overhead and slow beam switch. These limitations are particularly noticeable and costly when UE movement is considered. One example is that beam update using DCI can only be performed for PDSCH, and MAC-CE and/or RRC is required to update the beam for other reference signals/channels, which cause extra overhead and latency.

Furthermore, in majority of cases, the network transmits to and receive from a UE in the same direction for both data and control. Thus, using separate frameworks (TCI state respective spatial relations) for different channels/signals complicates the implementations.

In Rel-17, a common beam framework was introduced to simplify beam management in FR2, in which a common beam represent by a TCI state may be activated/indicated to a UE and the common beam is applicable for multiple channels/signals such as PDCCH and PDSCH. The common beam framework is also referred to a unified TCI state framework.

The new framework can be RRC configured in one out two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels.

A unified TCI state can be updated in a similar way as the TCI state update for PDSCH in Rel-15/16, i.e. with one of two alternatives:
Two-stage: RRC signaling is used to configure a number unified TCI states in higher layer parameter PDSCH-config, and a MAC-CE is used to activate one of unified TCI states
Three-stage: RRC signaling is used to configure a number unified TCI states in PDSCH-config, a MAC-CE is used to activate up to 8 unified TCI states, and a 3-bit TCI state bitfield in DCI is used to indicate one of the activate unified TCI states

The one activated or indicated unified TCI state will be used in subsequent both PDCCH and PDSCH transmissions until a new unified TCI state is activated or indicated.

The existing DCI formats 1_1 and 1_2 are reused for beam indication, both with and without DL assignment. For DCI formats 1_1 and 1_2 with DL assignment, Acknowledgement (ACK)/Non-Acknowledgement (NACK) of the PDSCH can be used as indication of successful reception of beam indication. For DCI formats 1_1 and 1_2 without DL assignment, a new ACK/NACK mechanism analogous to that for Semi Persistent Scheduling (SPS) PDSCH release with both type-1 and type-2 Hybrid Automatic Repeat Request-ACK (HARQ-ACK) codebook is used, where upon a successful reception of the beam indication DCI, the UE reports an ACK.

For DCI-based beam indication, the first slot to apply the indicated TCI is at least Y symbols after the last symbol of the acknowledgment of the joint or separate DL/UL beam indication. The Y symbols are configured by the gNB based on UE capability, which is also reported in units of symbols. The values of Y are yet not determined and is left to RAN4 to decide.

### Reference Signal Configurations

A CSI-RS is transmitted over each transmit (Tx) antenna port at the network node and for different antenna ports. The CSI-RS are multiplexed in time, frequency, and code domain such that the channel between each Tx antenna port at the network node and each receive antenna port at a UE can be measured by the UE. The time-frequency resource used for transmitting CSI-RS is referred to as a CSI-RS resource.

In NR, the CSI-RS for beam management is defined as a 1-or 2-port CSI-RS resource in a CSI-RS resource set where the filed repetition is present. The following three types of CSI-RS transmissions are supported:
Periodic CSI-RS: CSI-RS is transmitted periodically in certain slots. This CSI-RS transmission is semi-statically configured using RRC signaling with parameters such as CSI-RS resource, periodicity, and slot offset.
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling is needed to activate and deactivate the CSI-RS transmission.
Aperiodic CSI-RS: This is a one-shot CSI-RS transmission that can happen in any slot. Here, one-shot means that CSI-RS transmission only happens once per trigger. The CSI-RS resources (i.e., the RE locations which consist of subcarrier locations and OFDM symbol locations) for aperiodic CSI-RS are semi-statically configured. The transmission of aperiodic CSI-RS is triggered by dynamic signaling through PDCCH using the CSI request field in UL DCI, in the same DCI where the UL resources for the measurement report are scheduled. Multiple aperiodic CSI-RS resources can be included in a CSI-RS resource set and the triggering of aperiodic CSI-RS is on a resource set basis.

In NR, an SSB consists of a pair of synchronization signals (SSs), physical broadcast channel (PBCH), and DMRS for PBCH. A SSB is mapped to 4 consecutive OFDM symbols in the time domain and 240 contiguous subcarriers (20 RBs) in the frequency domain.

To support beamforming and beam-sweeping for SSB transmission, in NR, a cell can transmit multiple SSBs in different narrow-beams in a time multiplexed fashion. The transmission of these SSBs is confined to a half frame time interval (5 ms). It is also possible to configure a cell to transmit multiple SSBs in a single wide-beam with multiple repetitions. The design of beamforming parameters for each of the SSBs within a half frame is up to network implementation. The SSBs within a half frame are broadcasted periodically from each cell. The periodicity of the half frames with SS/PBCH blocks is referred to as SSB periodicity, which is indicated by SIBI.

The maximum number of SSBs within a half frame, denoted by L, depends on the frequency band, and the time locations for these L candidate SSBs within a half frame depends on the SCS of the SSBs. The L candidate SSBs within a half frame are indexed in an ascending order in time from 0 to L-1. By successfully detecting PBCH and its associated DMRS, a UE knows the SSB index. A cell does not necessarily transmit SS/PBCH blocks in all L candidate locations in a half frame, and the resource of the un-used candidate positions can be used for the transmission of data or control signaling instead. It is up to network implementation to decide which candidate time locations to select for SSB transmission within a half frame, and which beam to use for each SSB transmission.

### Measurement Resource Configurations

In NR, a UE can be configured with N>1 CSI reporting settings (i.e., CSI-ReportConfig), M≥1 resource settings (i.e., CSI-ResourceConfig), where each CSI reporting setting is linked to one or more resource setting for channel and/or interference measurement. The CSI framework is modular, meaning that several CSI reporting settings may be associated with the same Resource Setting.

The measurement resource configurations for beam management are provided to the UE by RRC Information Elements (IEs) CSI-ResourceConfigs. One CSI-ResourceConfig contains several NZP-CSI-RS-ResourceSets and/or CSI-SSB-ResourceSets.

A UE can be configured to perform measurement on CSI-RSs. Here the RRC IE NZP-CSI-RS-ResourceSet is used. A Non-Zero Power (NZP) CSI-RS resource set contains the configuration of Ks≥1 CSI-RS resources, where the configuration of each CSI-RS resource includes at least: mapping to REs, the number of antenna ports, time-domain behavior, etc. Up to 64 CSI-RS resources can be grouped to a NZP-CSI-RS-ResourceSet. A UE can also be configured to perform measurements on SSBs. Here, the RRC IE CSI-SSB-ResourceSet is used. Resource sets comprising SSB resources are defined in a similar manner.

In the case of aperiodic CSI-RS and/or aperiodic CSI reporting, the network node configures the UE with S_{c} CSI triggering states. Each triggering state contains the aperiodic CSI report setting to be triggered along with the associated aperiodic CSI-RS resource sets.

Periodic and semi-persistent Resource Settings can only comprise a single resource set (i.e., S=1) while S>=1 for aperiodic Resource Settings. This is because in the aperiodic case, one out of the S resource sets comprised in the Resource Setting is indicated by the aperiodic triggering state that triggers a CSI report.

### Measurement Reporting

Three types of CSI reporting are supported in NR as follows:
Periodic CSI Reporting on PUCCH: CSI is reported periodically by a UE. Parameters such as periodicity and slot offset are configured semi-statically by higher layer RRC signaling from the network node to the UE
Semi-Persistent CSI Reporting on PUSCH or PUCCH: similar to periodic CSI reporting, semi-persistent CSI reporting has a periodicity and slot offset which may be semi-statically configured. However, a dynamic trigger from network node to UE may be needed to allow the UE to begin semi-persistent CSI reporting. A dynamic trigger from network node to UE is needed to request the UE to stop the semi-persistent CSI reporting.
Aperiodic CSI Reporting on PUSCH: This type of CSI reporting involves a single-shot (i.e., one time) CSI report by a UE which is dynamically triggered by the network node using DCI. Some of the parameters related to the configuration of the aperiodic CSI report is semi-statically configured by RRC but the triggering is dynamic

In each CSI reporting setting, the content and time-domain behavior of the report is defined, along with the linkage to the associated Resource Settings. The CSI-ReportConfig IE comprise the following configurations:
reportConfigType: Defines the time-domain behavior, i.e. periodic CSI reporting, semi-persistent CSI reporting, or aperiodic CSI reporting, along with the periodicity and slot offset of the report for periodic CSI reporting.
reportQuantity: Defines the reported CSI parameter(s) (i.e. the CSI content), such as PMI, CQI, RI, LI (layer indicator), CRI (CSI-RS resource index) and L1-RSRP. Only a certain number of combinations are possible (e.g. ‘cri-RI-PMI-CQI’ is one possible value and ‘cri-RSRP’ is another) and each value of reportQuantity could be said to correspond to a certain CSI mode.
codebookConfig: Defines the codebook used for PMI reporting, along with possible codebook subset restriction (CBSR). Two “Types” of PMI codebook are defined in NR. Type I CSI and Type II CSI, each codebook type further has two variants each.
reportFrequencyConfiguration: Define the frequency granularity of PMI and CQI (wideband or subband), if reported, along with the CSI reporting band, which is a subset of subbands of the bandwidth part (BWP) which the CSI corresponds to measurement restriction in time domain (ON/OFF) for channel and interference respectively

For beam management, a UE can be configured to report L1-RSRP for up to four different CSI-RS/SSB resource indicators. The reported RSRP value corresponding to the first (best) CRI/SSBRI requires 7 bits, using absolute values, while the others require 4 bits using encoding relative to the first. In NR release 16, the report of L1-SINR for beam management has already been supported

### Beam Prediction Using AI/ML

One example AI/ML-model currently discussed in the AI for air-interface Rel-18 comprises predicting the channel in respect to a beam for a certain time-frequency resource. The expected performance of such predictor depends on several different aspects, for example time/frequency variation of channel due to UE mobility or changes in the environment. Due to the inherit correlation in time, frequency and the spatial domain of the channel, an ML-model can be trained to exploit such correlations. The spatial domain can comprise of different beams, where the correlation properties partly depend on the how the gNB antennas forms the different beams, and how UE forms the receiver beams.

The device can use such prediction ML-model to reduce its measurement related to beamforming. In NR, one can request a device to measure on a set of SSB beams or/and CSI-RS beams. A stationary device typically experiences less variations in beam quality in comparison to a moving device. The stationary device can therefore save battery and reduce the number of beam measurements by instead using an ML model to predict the beam quality without an explicit measurement. It can do this, for example, by measuring a subset of the beams and predicting the rest of the beams. According to RP-202650, for example, one can with use of Al measure on a subset of beams in order to predict the best beam, which can reduce up to 75% measurement time. See, https://www.3gpp.org/ftp/tsg_ran/TSG_RAN/TSGR_90e/Docs/RP-202650.zip.

Previous techniques have enabled a UE to predict future beam values based on historical values. Based on received device data from measurement reports, the network can learn, for example, which sequences of signal quality measurements (e.g., RSRP measurements) lead to large signal quality drop events (e.g., turning around the corners as illustrated in FIG. 2). This learning procedure can be enabled, for example, by dividing periodically reported RSRP data into a training and prediction window. FIG. 2 illustrates two devices moving on similar paths. In the example shown in FIG. 2, two devices move and turn around the same corner. Device 120b, marked by dashed line, is the first to turn around the corner and experience a large signal quality drop. The main idea is to mitigate the drop of a second device (120a) by using learning from the first device's experiences.

The learning can be done by feeding RSRP in t₁. . . , tₙ into a machine learning model (e.g., neural network), and then learn the RSRP in tₙ₊₁, tₙ₊₂. After the model is trained, the network can then predict future signal quality values, the signal quality prediction can then be used to avoid radio-link failure, or beam failure, by:
Initiate inter-frequency handover
Set handover/reselection parameters
Pre-emptively perform candidate beam selection to avoid beam failure
Change device scheduler priority, for example schedule device when the expected signal quality is good

There currently exist certain challenge(s), however. For example, development into AI/ML for mobile communication systems implies moving into data collection era since the ML models requires a lot of data for training the neural network.

Data collection is a new functionality for the physical layer, since the UE need to perform a measurement without an immediate effect on the ongoing connection. This may be contrasted with, for example, CSI measurement or reporting, where the measurement is used rather soon by the network to enhance subsequent transmission. Current 3GPP based systems and associated measurements are not designed for data collection, which is a problem when introducing AI/ML and legacy CSI acquisition methods needs to be used, which is costly in overhead and battery consumption.

The more data that is collected the better the AI/ML models will be trained. One problem with collecting data, however, is that it consumes overhead. This is especially true for a beam management procedure where main part of the beam measurements is UE specific (e.g., the P2 beam sweep is typically aperiodically triggered which only can be do in a UE specific way in the current NR specification). Thus, it is a problem with PDCCH overhead to trigger a measurement for beam measurement, especially for data collection when machine learning based algorithm is used and trained. There is also a problem with beam RS (SSB or CSI-RS, for example) overhead, especially if there are many UEs in the cell that needs to perform data collection.

### SUMMARY

Certain aspects of the disclosure and their embodiments may provide solutions to these or other challenges. For example, low overhead methods and systems are provided for performing measurements for data collection at multiple UEs in a cell.

According to certain embodiments, a method by a first UE for data collection includes receiving, from a network node, a first message configuring one or more downlink reference signal resources. The first UE receives, from the network node, a second message comprising an indication to monitor a communication channel associated with a RNTI for data collection. The first UE receives a third message comprising DCI associated with the RNTI for data collection. The third message indicates to the UE to perform measurements on one or more of the downlink reference signal resources. Based on the third message comprising the DCI associated with the RNTI for data collection, the first UE performs at least one measurement on a downlink reference signal transmitted for a second UE. The downlink reference signal is transmitted on one of the one or more indicated downlink reference signal resources.

According to certain embodiments, a first UE for data collection includes processing circuitry adapted to receive, from a network node, a first message configuring one or more downlink reference signal resources. The first UE is adapted to receive, from the network node, a second message comprising an indication to monitor a communication channel associated with a RNTI for data collection. The first UE is adapted to receive a third message comprising DCI associated with the RNTI for data collection. The third message indicates to the UE to perform measurements on one or more of the downlink reference signal resources. Based on the third message comprising the DCI associated with the RNTI for data collection, the first UE is adapted to perform at least one measurement on a downlink reference signal transmitted for a second UE. The downlink reference signal is transmitted on one of the one or more indicated downlink reference signal resources.

According to certain embodiments, a method by a network node for data collection includes transmitting, to a first UE, a first message configuring one or more downlink reference signal resources. The network node transmits, to the first UE, a second message comprising an indication to monitor a communication channel associated with a RNTI for data collection. The network node transmits, to the first UE, a third message comprising DCI associated with the RNTI for data collection. The third message indicates to the first UE to perform measurements on the one or more downlink reference signal resources. Based on the third message comprising the DCI associated with the RNTI for data collection, the network node transmits a reference signal to a second UE. The reference signal is transmitted on one of the one or more indicated downlink reference signal resources.

According to certain embodiments, a network node for data collection includes processing circuitry adapted to transmit, to a first UE, a first message configuring one or more downlink reference signal resources. The network node is adapted to transmit, to the first UE, a second message comprising an indication to monitor a communication channel associated with a RNTI for data collection. The network node is adapted to transmit, to the first UE, a third message comprising DCI associated with the RNTI for data collection. The third message indicates to the first UE to perform measurements on the one or more downlink reference signal resources. Based on the third message comprising the DCI associated with the RNTI for data collection, the network node is adapted to transmit a reference signal to a second UE. The reference signal is transmitted on one of the one or more indicated downlink reference signal resources.

Certain embodiments may provide one or more of the following technical advantage(s). For example, certain embodiments may provide a technical advantage of enabling data collection for UEs not intended for the actual transmission. As a result, certain embodiments may increase the available collected data relative to the overhead signaling. For a beam management use case, for example, this may lead to better performance of beam predicting AI/ML models for 5G advance and/or 6G.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example beam management procedure;

FIG. 2 illustrates two devices moving on similar paths;

FIG. 3 illustrates an example beam sweep procedure, according to certain embodiments;

FIG. 4 illustrates a flowchart and signaling diagram for a high-level method, according to certain embodiments;

FIG. 5 illustrates an example communication system, according to certain embodiments;

FIG. 6 illustrates an example UE, according to certain embodiments;

FIG. 7 illustrates an example network node, according to certain embodiments;

FIG. 8 illustrates a block diagram of a host, according to certain embodiments;

FIG. 9 illustrates a virtualization environment in which functions implemented by some embodiments may be virtualized, according to certain embodiments;

FIG. 10 illustrates a host communicating via a network node with a UE over a partially wireless connection, according to certain embodiments;

FIG. 11 illustrates an example method by a first UE for data collection, according to certain embodiments; and

FIG. 12 illustrates a method by a network node for data collection, according to certain embodiments.

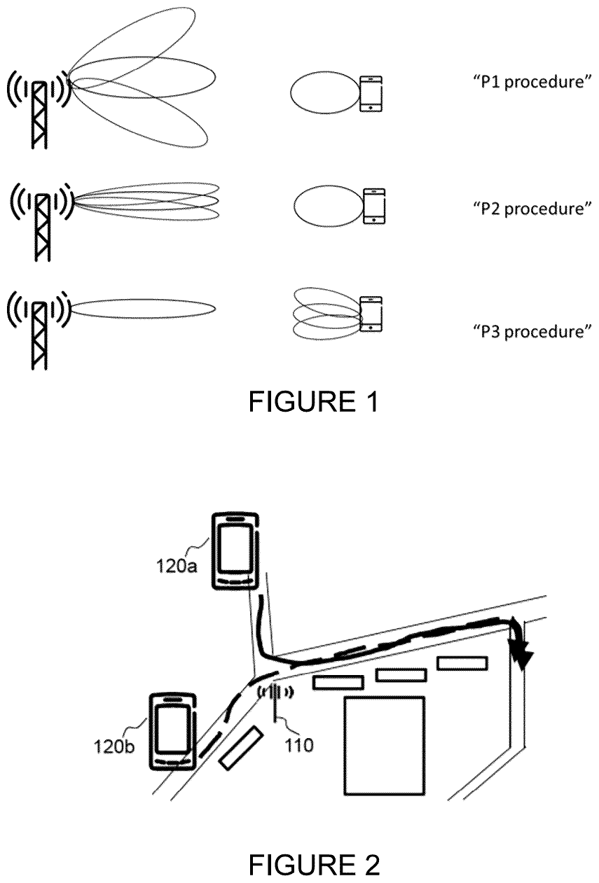

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station. radio base station, base transceiver station, base station controller, network controller, evolved Node B (eNB), Node B, gNodeB (gNB), relay node, access point, radio access point. Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IOT), WiFi, Bluetooth, next generation RAT, NR, 4G, 5G, etc. Any of the equipment denoted by the terms node, network node or radio network node may be capable of supporting a single or multiple RATs.

Herein, the words “beam” (i.e. a spatial filter) and “reference signal” are interchangeably used.

It is noted, that though certain embodiments are described with respect to the beam management use case, the methods and systems disclosed herein should not be limited to the beam management use case. Rather, the methods and systems disclosed herein are applicable to any use case where data collection is useful also for other types for AI/ML applications such as, for example, CSI enhancements, mobility, positioning, etc.

According to certain embodiments described herein, low overhead methods and systems are provided for performing measurements for data collection at multiple UEs in a cell. An example scenario includes an intended UE A for which a measurement and a report is triggered and a set of observing UEs B1, . . . , Bn, which only perform measurements for data collection. The set of observing UEs takes advantage of the fact that the network is scheduled for transmitting RS to UE A and perform their own measurements on the RS intended for UE A to collect data. There is, thus, no report associated with the measurements at the observing UEs. Thus, the problem to solve is how to indicate to the observing UEs where and when these RS are present so measurement can be made.

Certain embodiments described herein relate, for example, to a beam management use case where UE A is (aperiodically) triggered to measure and report on a set of beam RSs, and the observing set of UEs are also triggered to measure on the same set of beam RSs using a group PDCCH message (thus received by the observing UEs). For example, assume two UEs (UE A and UE B) reside in the same SSB beam coverage area. UE A is triggered with an aperiodic P2 beam sweep to evaluate N narrow beams confined within the SSB. At the same time, a UE B is informed about the aperiodic P2 beam sweep aimed for UE A. According to certain embodiments, UE B can perform measurements on the P2 beam sweep for data collection purposes.

According to certain embodiments, systems and methods are provided for collecting data for training an AI/ML model. For example, a method in a wireless device (i.e. a UE in set B) may include
a, receiving a message containing a field DL reference signal configuration, wherein the DL reference signal configuration configures one or more aperiodic DL reference signal resource sets;
b, optionally, receiving a message containing a field Network node beam configuration, wherein the Network node beam configuration indicates information about network node beams (spatial filters) using Beam IDs;
c, optionally, receiving a message containing a field Search space configuration, wherein the Search space configuration contains an indication that it may monitor a PDCCH of a data_collection_measurement -RNTI;
d, if and/or when the UE has decided to perform the data collection, receiving and decoding a PDCCH, which comprises information about which RS (and when) to measure for data collection (i.e., optionally, for example, the CRC is scrambled by the data_collection_measurement -RNTI); and/or
e, performing the measurements.

Optionally, according to a particular embodiment, the PDCCH of a data_collection_measurement -RNTI triggers a measurement of one or more of the aperiodic DL reference signal resource sets configured in DL reference signal configuration.

Optionally, according to a particular embodiment, the PDCCH of a data_collection_measurement -RNTI indicates an aperiodic trigger state.

Optionally, according to a particular embodiment, the UE receives an indication of an aperiodic trigger state through a PDCCH of a data_collection_measurement -RNTI, and the UE ignores any potential CSI report configured as associated with that aperiodic trigger state. Thus, the UE may not transmit a report in UCI in this case.

Optionally, according to a particular embodiment, for the beam management use case the PDCCH of a data_collection_measurement -RNTI indicates the beams (spatial filters) used by the network node when transmitting the triggered aperiodic DL reference signal resource set(s).

Optionally, according to a particular embodiment, the indication of beams (spatial filer) is associated with a set of Beam IDs. In a further particular embodiment, the indication of beams (spatial filer) is done by indicating a set of DL-RS resource (using DL-R resource IDs), and where each DL-RS resource is associated with a beam (spatial filter). In yet another particular embodiment, the indication of beams (spatial filer) is done through an indicated aperiodic trigger state, and the beams (spatial filters) are configured per aperiodic trigger state.

Optionally, according to a particular embodiment, beams (spatial filters) are configured in the aperiodic trigger state by using the Beam IDs.

Optionally, according to a particular embodiment, the QCL relation for the triggered DL-RS resources are indicated in the PDCCH of a data_collection_measurement -RNTI.

Optionally, according to a particular embodiment, the QCL relation is indicated with a list of TCI states (TCI state IDs).

Optionally, according to a particular embodiment, the Network node beam configuration contains a list of Beam IDs.

Optionally, according to a particular embodiment, spatial correlations and/or QCL relations are indicated for the Beam IDs.

Optionally, according to a particular embodiment, each Beam ID is associated with a DL-RS resource.

Optionally, according to a particular embodiment, the UE reports to the network node the capability to support data collection for beam prediction based on reference signals intended to another UE.

The main focus of certain embodiments described herein is data collection. As noted above, particular embodiments relate to beam management and, specifically, to beam prediction. Accordingly, in certain embodiments, the UE is configured with a DL reference signal configuration within a message. This message can for example be an RRCReconfiguration message or a MAC CE. The DL reference configuration contains configurations one or more aperiodic DL reference signal resource sets. The reference signals can, for example, be CSI-RS.

In a particular embodiment, the UE is further configured to monitor a PDCCH of a data_collection_measurement -RNTI. In one embodiment, the PDCCH of a measurement-RNTI is a broadcasted PDCCH, which means that it is associated with a cell specific search space.

In a particular embodiment, the UE is configured with a Network node beam configuration within a message. This message can, for example, be an RRCReconfiguration message or an MAC CE. In the Network node beam configuration, one or more of the following information can be included:
A list of Beam IDs
Spatial correlation between Beam IDs
Spatial correlation between Beam IDs and other reference signals.
QCL relations between Beam IDs and other reference signals
Association between a Beam ID and a DL reference signal resource (i.e. which DL-RS resource that is transmitted with a certain Beam ID)

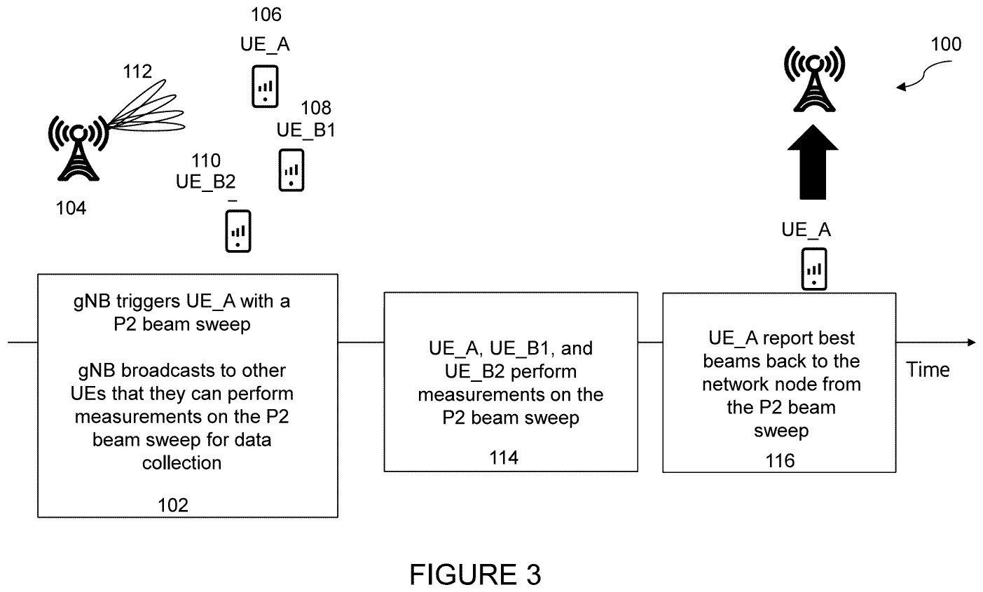

FIG. 3 illustrates an example beam sweep procedure 100, according to certain embodiments. Specifically, in a first step 102, the gNB 104 triggers UE A 106 with an aperiodic P2 beam sweep 112. The gNB 104 also broadcasts a PDCCH with a data_collection_measurement -RNTI, for example, to the observing UEs 106, 108 of the cell, configuring them to perform measurements for data collection on the DL-reference signals associated with P2 beam sweep intended for UE A 106.

In the second step 114, UE A 106, UE B1 108, and UE B2 110 perform measurements on the P2 beam sweep 112 intended for UE A 106.

In the third step 116, only the UE A 106 performs a beam report associated with the P2 beam sweep 112, while the remaining observing UEs 108, 110 use the measurements only for data collection purposes.

According to certain embodiments, whether an observing UE 108, 110 perform data collection or not may be up to UE implementation. For example, if the UE is not otherwise performing data collection for a reason such as saving battery, then the UE may also abstain from monitoring the data_collection_measurement-RNTI that is associated with the beam sweep procedure. Thus, in a particular embodiment, the configuring of the search space to monitor data_collection_measurement-RNTI is merely a service made available to the UE by the network to the UE, and whether the UE determines to perform the data_collection_measurements in a certain slot or not is agnostic to the network.

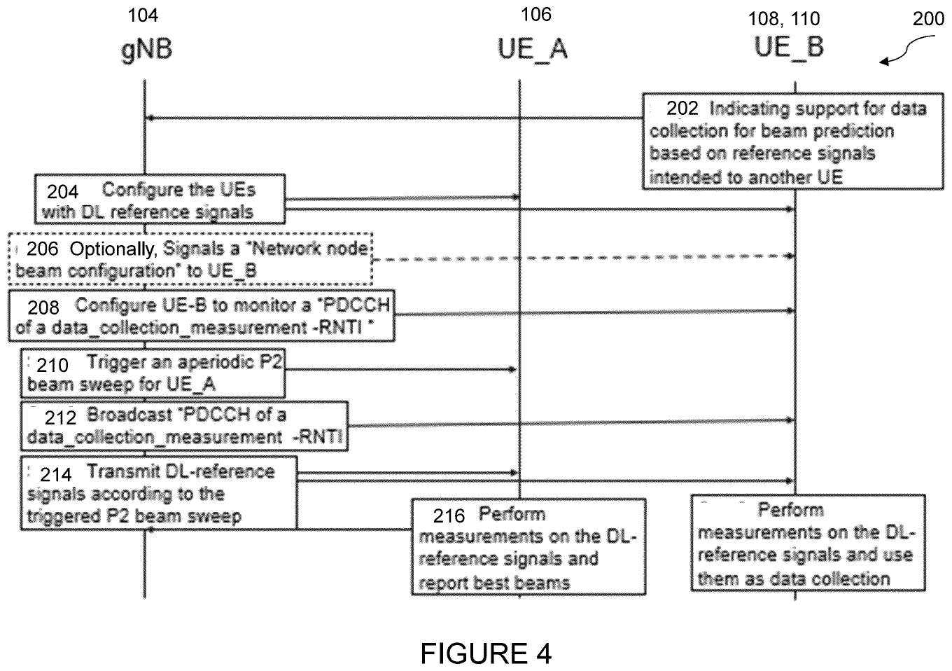

FIG. 4 illustrates a flowchart and signaling diagram 200 for a high-level method, according to certain embodiments. Specifically, at Step 202, the UE B 108, 110 reports during, for example, UE capability signaling, an indication that the UE supports data collection for beam prediction based on reference signals intended to another UE such as, for example, UE 106.

In Step 204, the gNB 104 configures the UEs with aperiodic DL-RS resources.

In an optional Step 206, the gNB 104 signals Network node beam configuration to the UE B 108, 110, where the potential information conveyed in Network node beam configuration is listed above.

In a Step 208, the gNB 104 configures UE-B 108, 110 to monitor a PDCCH of a data_collection_measurement -RNTI.

In a Step 210, the gNB 104 triggers a PA beam sweep 112 for UE A 106.

During a time in close vicinity to step 210, the gNB 104 performs Step 212 and broadcasts a PDCCH of a data_collection_measurement -RNTI which is received and decoded by UE-B 108, 110. The PDCCH of a data_collection_measurement -RNTI indicates to UE-B 108, 110 that the gNB 104 will transmit a number of DL-reference signals in a number of gNB beams (aimed for another UE 106).

In a Step 214, the gNB 104 transmits the DL reference signals in the set of gNB beams and both UE A 106 and UE B 108, 110 performs measurements on the DL-reference signals.

In a Step 216, the UE A 106 reports back the best N beams (according to legacy beam management procedures), while UE B 108, 110 only stores the measurements for data collection purposes.

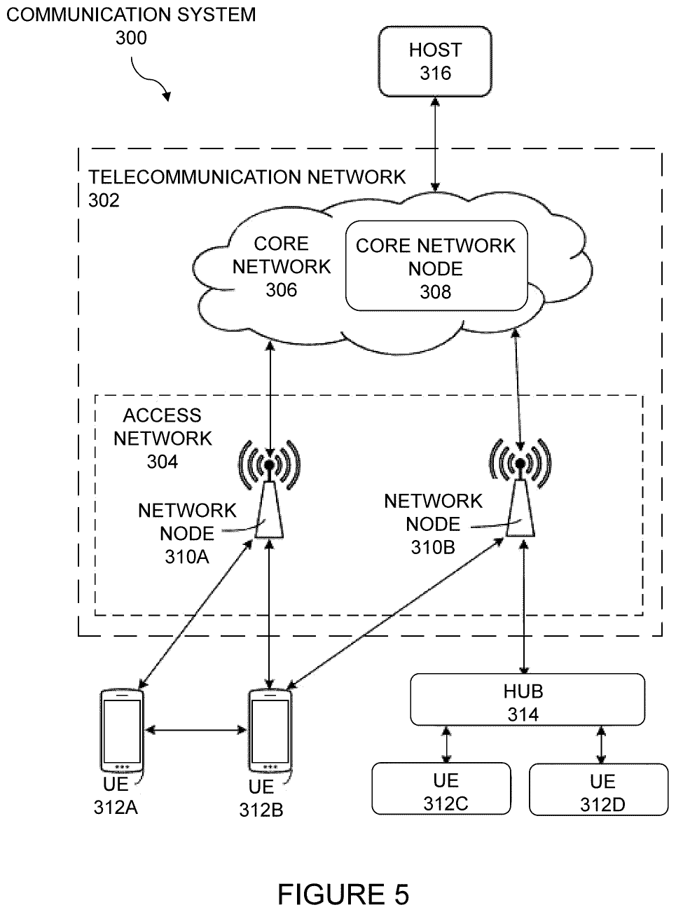

FIG. 5 shows an example of a communication system 300 in accordance with some embodiments. In the example, the communication system 300 includes a telecommunication network 302 that includes an access network 304, such as a radio access network (RAN), and a core network 306, which includes one or more core network nodes 308. The access network 304 includes one or more access network nodes, such as network nodes 310a and 310b (one or more of which may be generally referred to as network nodes 310), or any other similar 3^{rd} Generation Partnership Project (3GPP) access node or non-3GPP access point. The network nodes 310 facilitate direct or indirect connection of user equipment (UE), such as by connecting UEs 312a, 312b, 312c, and 312d (one or more of which may be generally referred to as UEs 312) to the core network 306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC). Mobility Management Entity (MME). Home Subscriber Server (HSS). Access and Mobility Management Function (AMF). Session Management Function (SMF). Authentication Server Function (AUSF). Subscription Identifier De-concealing function (SIDF). Unified Data Management (UDM). Security Edge Protection Proxy (SEPP). Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices. functions for an alarm and surveillance center, or any other such function performed by a server.

As a whole, the communication system 300 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 302 is a cellular network that implements 3GPP standardized features. Accordingly, the telecommunications network 302 may support network slicing to provide different logical networks to different devices that are connected to the telecommunication network 302. For example, the telecommunications network 302 may provide Ultra Reliable Low Latency Communication (URLLC) services to some UEs. while providing Enhanced Mobile Broadband (eMBB) services to other UEs, and/or Massive Machine Type Communication (mMTC)/Massive IoT services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 314 communicates with the access network 304 to facilitate indirect communication between one or more UEs (e.g., UE 312c and/or 312d) and network nodes (e.g., network node 310b). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs. network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a VR headset, display. loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular in if one or more of the UEs are low energy IoT devices.

The hub 314 may have a constant/persistent or intermittent connection to the network node 310b. The hub 314 may also allow for a different communication scheme and/or schedule between the hub 314 and UEs (e.g., UE 312c and/or 312d), and between the hub 314 and the core network 306. In other examples, the hub 314 is connected to the core network 306 and/or one or more UEs via a wired connection. Moreover, the hub 314 may be configured to connect to an M2M service provider over the access network 304 and/or to another UE over a direct connection. In some scenarios. UEs may establish a wireless connection with the network nodes 310 while still connected via the hub 314 via a wired or wireless connection. In some embodiments, the hub 314 may be a dedicated hub-that is, a hub whose primary function is to route communications to/from the UEs from/to the network node 310b. In other embodiments, the hub 314 may be a non-dedicated hub-that is, a device which is capable of operating to route communications between the UEs and network node 310b, but which is additionally capable of operating as a communication start and/or end point for certain data channels.

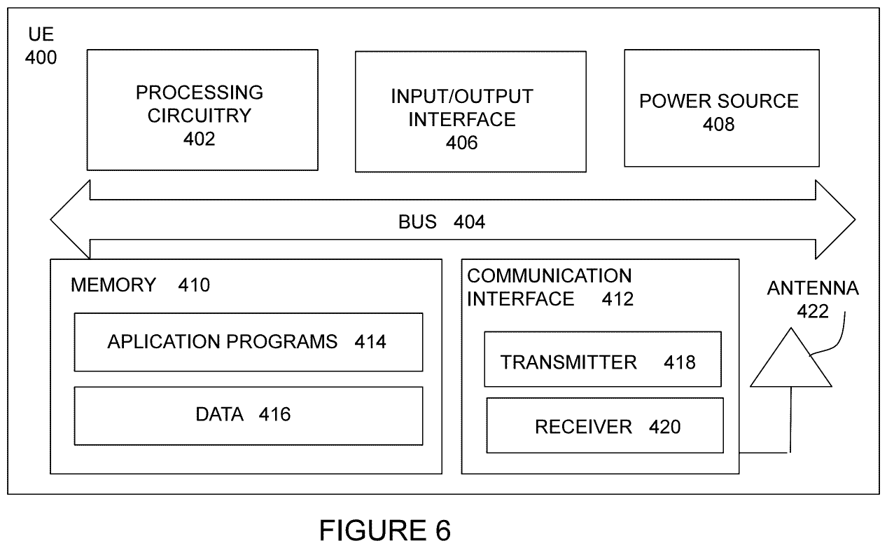

FIG. 6 shows a UE 400 in accordance with some embodiments. As used herein, a UE refers to a device capable, configured, arranged and/or operable to communicate wirelessly with network nodes and/or other UEs. Examples of a UE include, but are not limited to, a smart phone. mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station. tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication. Dedicated Short-Range Communication (DSRC). vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, a memory 410, a communication interface 412. and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, field-programmable gate arrays (FPGAs), application specific integrated circuits (ASICs), etc.);

programmable logic together with appropriate firmware; one or more stored computer programs. general-purpose processors, such as a microprocessor or digital signal processor (DSP), together with appropriate software; or any combination of the above. For example, the processing circuitry 402 may include multiple central processing units (CPUs).

In the example, the input/output interface 406 may be configured to provide an interface or interfaces to an input device, output device, or one or more input and/or output devices. Examples of an output device include a speaker, a sound card, a video card, a display, a monitor. a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet). photovoltaic device, or power cell, may be used. The power source 408 may further include power circuitry for delivering power from the power source 408 itself, and/or an external power source. to the various parts of the UE 400 via input circuitry or an interface such as an electrical power cable. Delivering power may be, for example, for charging of the power source 408. Power circuitry may perform any formatting, converting, or other modification to the power from the power source 408 to make the power suitable for the respective components of the UE 400 to which power is supplied.

The memory 410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives. and so forth. In one example, the memory 410 includes one or more application programs 414. such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive. Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 410 may allow the UE 400 to access instructions, application programs and the like, stored on transitory or non-transitory memory media, to off-load data, or to upload data. An article of manufacture, such as one utilizing a communication system may be tangibly embodied as or in the memory 410. which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., antenna 422) and may share circuit components, software or firmware, or alternatively be implemented separately.

In the illustrated embodiment, communication functions of the communication interface 412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 400 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

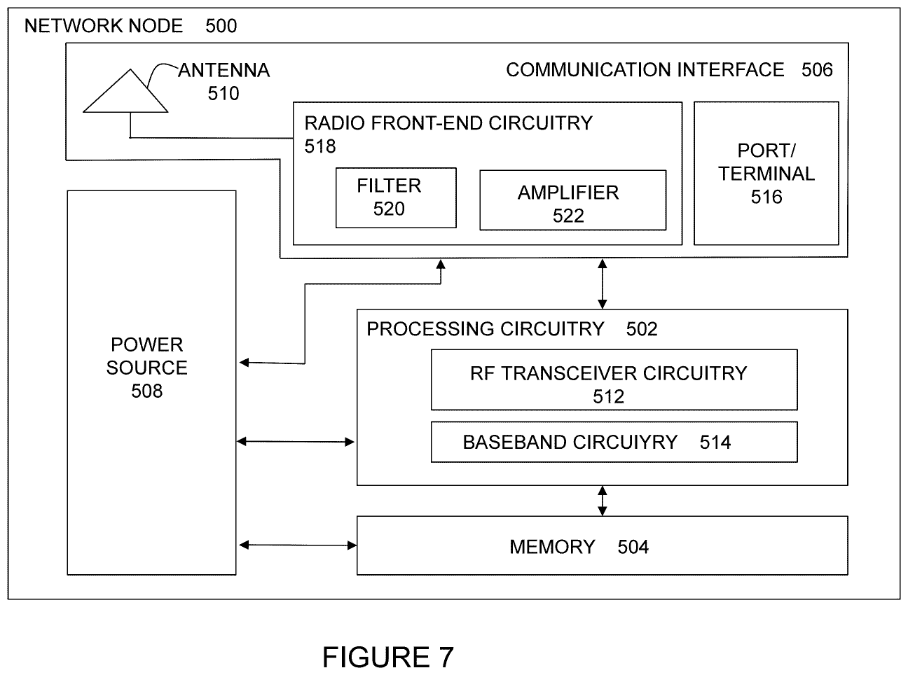

FIG. 7 shows a network node 500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 500 includes a processing circuitry 502, a memory 504, a communication interface 506, and a power source 508. The network node 500 may be composed of multiple physically separate components (e.g., a NodeB component and a RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 500 may be configured to support multiple radio access technologies (RATs). In such embodiments, some components may be duplicated (e.g., separate memory 504 for different RATs) and some components may be reused (e.g., a same antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, LoRaWAN. Radio Frequency Identification (RFID) or Bluetooth wireless technologies. These wireless technologies may be integrated into the same or different chip or set of chips and other components within network node 500.

The processing circuitry 502 may comprise a combination of one or more of a microprocessor, controller, microcontroller, central processing unit, digital signal processor. application-specific integrated circuit, field programmable gate array, or any other suitable computing device, resource, or combination of hardware, software and/or encoded logic operable to provide, either alone or in conjunction with other network node 500 components, such as the memory 504, to provide network node 500 functionality.

In some embodiments, the processing circuitry 502 includes a system on a chip (SOC). In some embodiments, the processing circuitry 502 includes one or more of radio frequency (RF) transceiver circuitry 512 and baseband processing circuitry 514. In some embodiments, the radio frequency (RF) transceiver circuitry 512 and the baseband processing circuitry 514 may be on separate chips (or sets of chips), boards, or units, such as radio units and digital units. In alternative embodiments, part or all of RF transceiver circuitry 512 and baseband processing circuitry 514 may be on the same chip or set of chips, boards, or units.

The memory 504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and memory 504 is integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510. Radio front-end circuitry 518 comprises filters 520 and amplifiers 522. The radio front-end circuitry 518 may be connected to an antenna 510 and processing circuitry 502. The radio front-end circuitry may be configured to condition signals communicated between antenna 510 and processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of filters 520 and/or amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface may comprise different components and/or different combinations of components.

In certain alternative embodiments, the network node 500 does not include separate radio front-end circuitry 518, instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes one or more ports or terminals 516, the radio front-end circuitry 518, and the RF transceiver circuitry 512, as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, communication interface 506, and/or the processing circuitry 502 may be configured to perform any receiving operations and/or certain obtaining operations described herein as being performed by the network node. Any information, data and/or signals may be received from a UE, another network node and/or any other network equipment. Similarly, the antenna 510, the communication interface 506, and/or the processing circuitry 502 may be configured to perform any transmitting operations described herein as being performed by the network node. Any information, data and/or signals may be transmitted to a UE, another network node and/or any other network equipment.

The power source 508 provides power to the various components of network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid, an electricity outlet) via an input circuitry or interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 7 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

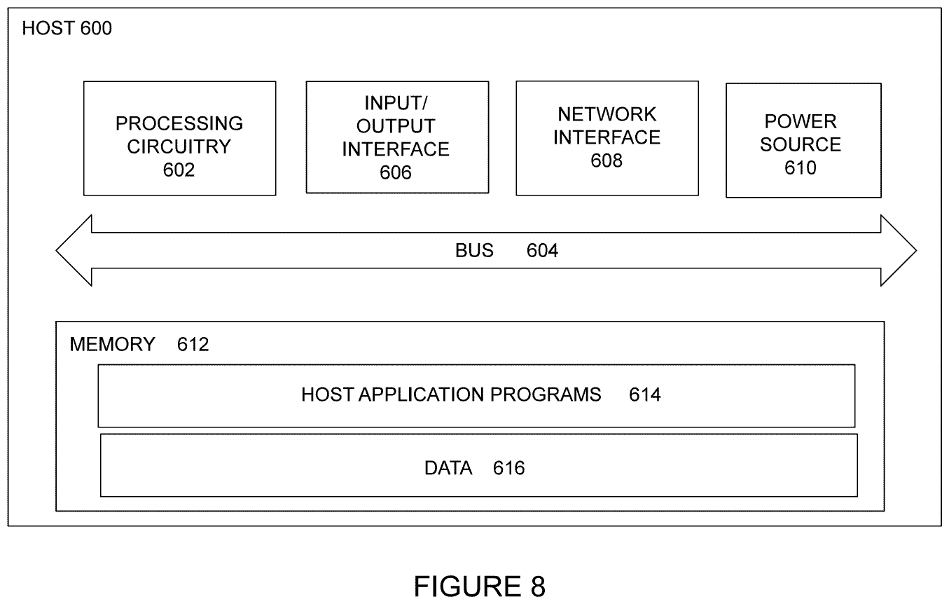

FIG. 8 is a block diagram of a host 600, which may be an embodiment of the host 316 of FIG. 5, in accordance with various aspects described herein. As used herein, the host 600 may be or comprise various combinations hardware and/or software, including a standalone server, a blade server, a cloud-implemented server, a distributed server, a virtual machine, container, or processing resources in a server farm. The host 600 may provide one or more services to one or more UEs.

The host 600 includes processing circuitry 602 that is operatively coupled via a bus 604 to an input/output interface 606, a network interface 608, a power source 610, and a memory 612. Other components may be included in other embodiments. Features of these components may be substantially similar to those described with respect to the devices of previous figures, such as FIGS. 4 and 5, such that the descriptions thereof are generally applicable to the corresponding components of host 600.

The memory 612 may include one or more computer programs including one or more host application programs 614 and data 616, which may include user data, e.g., data generated by a UE for the host 600 or data generated by the host 600 for a UE. Embodiments of the host 600 may utilize only a subset or all of the components shown. The host application programs 614 may be implemented in a container-based architecture and may provide support for video codecs (e.g., Versatile Video Coding (VVC). High Efficiency Video Coding (HEVC). Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 614 may also provide for user authentication and licensing checks and may periodically report health, routes, and content availability to a central node, such as a device in or on the edge of a core network. Accordingly, the host 600 may select and/or indicate a different host for over-the-top services for a UE. The host application programs 614 may support various protocols, such as the HTTP Live Streaming (HLS) protocol. Real-Time Messaging Protocol (RTMP). Real-Time Streaming Protocol (RTSP). Dynamic Adaptive Streaming over HTTP (MPEG-DASH), etc.

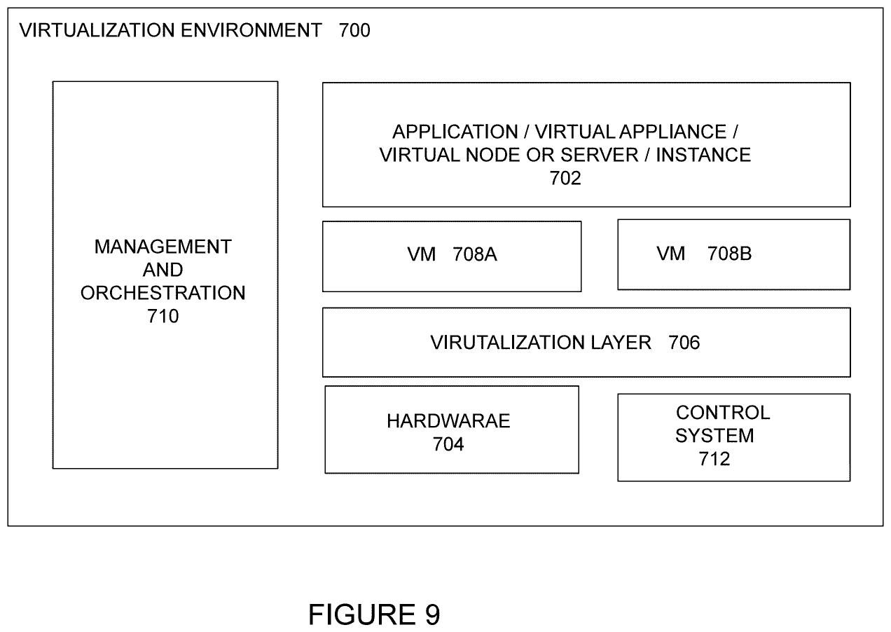

FIG. 9 is a block diagram illustrating a virtualization environment 700 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node. UE, core network node, or host. Further, in embodiments in which the virtual node does not require radio connectivity (e.g., a core network node or host), then the node may be entirely virtualized.

Applications 702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 712 which may alternatively be used for communication between hardware nodes and radio units.

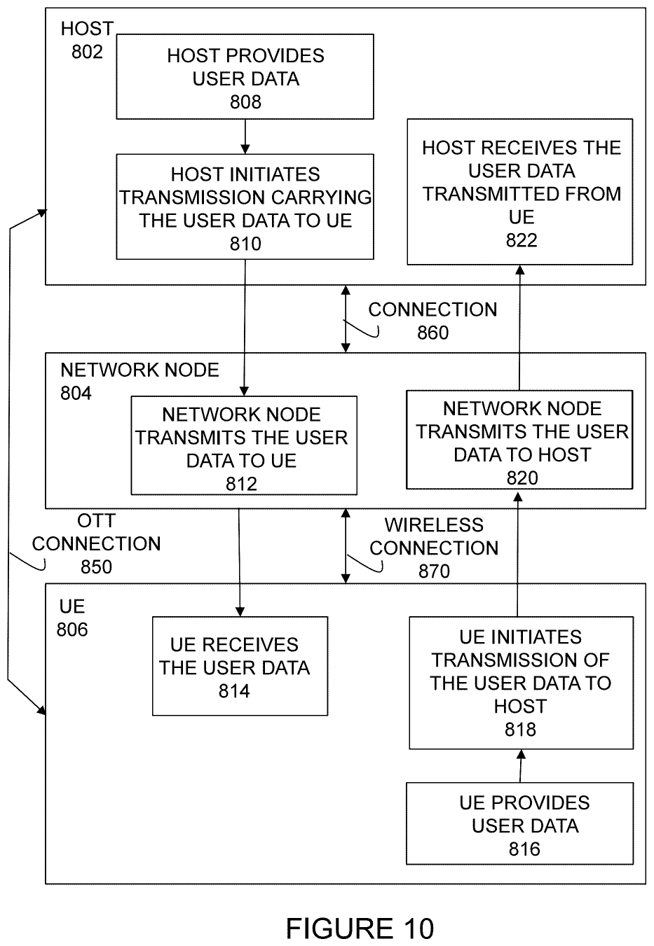

FIG. 10 shows a communication diagram of a host 802 communicating via a network node 804 with a UE 806 over a partially wireless connection in accordance with some embodiments.

Example implementations, in accordance with various embodiments, of the UE (such as a UE 312a of FIG. 5 and/or UE 400 of FIG. 6), network node (such as network node 310a of FIG. 5 and/or network node 500 of FIG. 7), and host (such as host 316 of FIG. 5 and/or host 600 of FIG. 8) discussed in the preceding paragraphs will now be described with reference to FIG. 10.

Like host 600, embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 306 of FIG. 5) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio. VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing. analyzing and/or transmitting data.

In some examples, a measurement procedure may be provided for the purpose of monitoring data rate, latency and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes: the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings. preferred routing etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

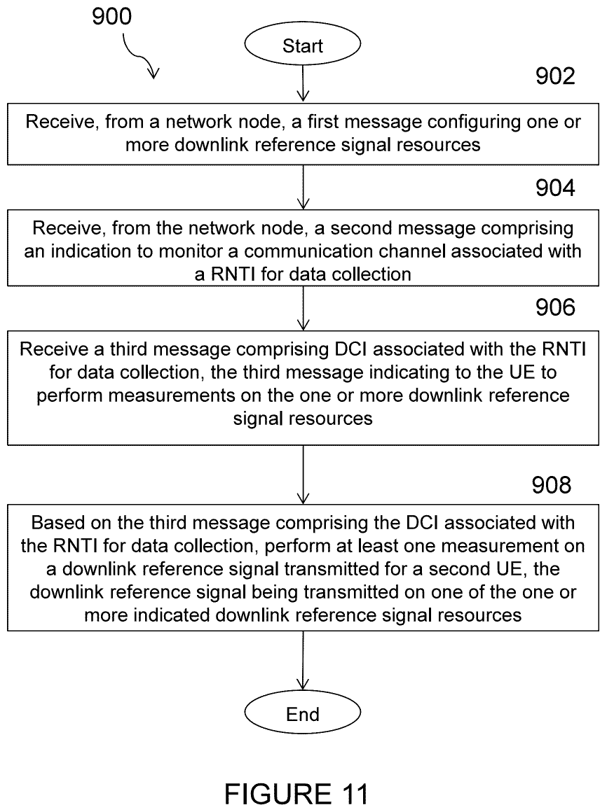

FIG. 11 illustrates an example method 900 by a first UE 108, 110, for data collection, according to certain embodiments. As depicted, the method begins at step 902 when the first UE 108, 110 receives, from a network node 104, a first message configuring one or more downlink reference signal resources. At step 904, the first UE 108, 110 receives, from the network node 104, a second message comprising an indication to monitor a communication channel associated with a RNTI for data collection. At step 906, the first UE 108, 110 receives a third message comprising DCI associated with the RNTI for data collection. The third message indicates to the UE to perform measurements on the one or more of the downlink reference signal resources. Based on the third message comprising the DCI associated with the RNTI for data collection, the first UE 108, 110 performs at least one measurement on a downlink reference signal transmitted for a second UE, at step 908. The downlink reference signal is transmitted on one of the one or more indicated downlink reference signal resources.

In a particular embodiment, the first UE 108, 110 uses the at least one measurement to train an AI and/or ML model.

In a particular embodiment, the first UE 108, 110 uses the AI and/or ML model for beam management and/or beam prediction.

In a particular embodiment, the one or more downlink reference signal resources comprises one or more aperiodic downlink reference signal resources.

In a particular embodiment, the third message including the DCI indicates when to measure the communication channel for the reference signal to be transmitted for the second UE 106.

In a particular embodiment, the first UE 108, 110 receives a network node beam configuration.

In a further particular embodiment, the network node beam configuration includes at least one of: at least one beam identifier, at least one spatial correlation and/or QCL relation between beam identifiers, at least one spatial correlation and/or QCL relation between at least one beam identifier and at least one downlink reference signal resource, and association between at least one beam identifier and a downlink reference signal resource.

In a further particular embodiment, each beam identifier is associated with one resource within the one or more downlink reference signal resources.

In a particular embodiment, the network node beam configuration is received in the second message, the network node beam configuration is received in the third message, or the network node beam configuration is received in a fourth message.

In a particular embodiment, the RNTI indicates an aperiodic trigger state.

In a particular embodiment, based on the aperiodic trigger state, the first UE 108, 110 ignores or determines not to send a CSI report.

In a particular embodiment, a QCL relation for at least one downlink reference signal resource is indicated in the communication channel associated with the RNTI.

In a further particular embodiment, the QCL relation is indicated with a list of TCI state identifiers.

In a particular embodiment, the first UE 108, 110 transmits, to the network node 104, information indicating a capability of the first UE to support data collection for beam prediction based on the reference signal intended for the second UE.

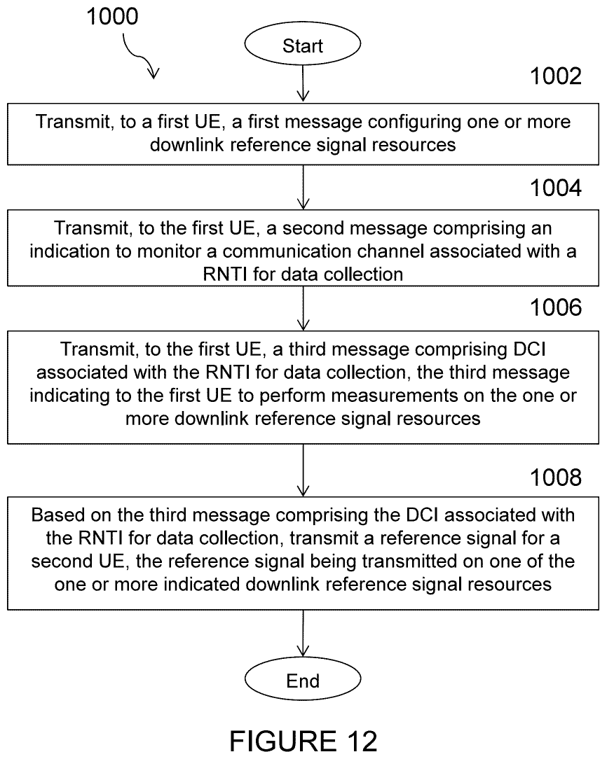

FIG. 12 illustrates a method 1000 by a network node 104 for data collection, according to certain embodiments. As depicted, the method begins at step 1002 when the network node 104 transmits, to a first UE 108, 110, a first message configuring one or more downlink reference signal resources. At step 1004, the network node 104 transmits, to the first UE 108, 110, a second message comprising an indication to monitor a communication channel associated with a RNTI for data collection. At step 1006, the network node 104 transmits, to the first UE 108, 110, a third message comprising DCI associated with the RNTI for data collection. The third message indicates to a first UE 108, 110 to perform measurements on the one or more downlink reference signal resources. Based on the third message comprising the DCI associated with the RNTI for data collection, the network node 104 transmits a reference signal to a second UE 106. The reference signal is transmitted on one of the one or more indicated downlink reference signal resources.

In a particular embodiment, the network node 104 configures the first UE 108, 110 to perform at least one measurement on the reference signal transmitted for the second UE 106.

In a particular embodiment, the network node 104 configures the first UE 108, 110 to use the at least one measurement to train an AI and/or ML model.

In a particular embodiment, the network node 104 uses the AI and/or ML model for beam management and/or beam prediction.

In a particular embodiment, the one or more downlink reference signal resources comprises one or more aperiodic downlink reference signal resources.

In a particular embodiment, the third message comprising the DCI indicates when to measure the communication channel for the reference signal to be transmitted to the second UE.

In a particular embodiment, the network node 104 transmits, to the first UE 108, 110, a network node beam configuration.

In a further particular embodiment, the network node beam configuration comprises at least one of: at least one beam identifier, at least one spatial correlation and/or quasi co-located, QCL, relation between beam identifiers, at least one spatial correlation and/or QCL relation between at least one beam identifier and at least one reference signal, and association between at least one beam identifier and a downlink reference signal resource.

In a particular embodiment, each beam identifier is associated with one of the one or more downlink reference signal resources.

In a particular embodiment, the network node beam configuration is transmitted in the second message, the network node beam configuration is transmitted in the third message, or the network node beam configuration is transmitted in a fourth message.

In a particular embodiment, the RNTI indicates an aperiodic trigger state. In a particular embodiment, the network node 104 configures the first UE 108, 110 to, based on the aperiodic trigger state, ignore or determine not to send a CSI report.

In a particular embodiment, a QCL relation for at least one downlink reference signal resource is indicated in the communication channel associated with the RNTI.

In a further particular embodiment, the QCL relation is indicated with a list of TCI state identifiers.

In a particular embodiment, the network node 104 receives, from the first UE 108, 110, information indicating a capability of the first UE 18, 110 to support data collection for beam prediction based on the reference signal intended for the second UE 106.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment (UE) for data collection, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data: and forwarding the user data to a host computer via the transmission to the network node.

### Group B Example Embodiments

Example Embodiment B1. A method performed by a network node for data collection, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a first user equipment (UE) for data collection, the method comprising: receiving, from a network node, a first message comprising information associated with at least one signal intended for transmission to a second UE; and performing at least one action based on the information.

Example Embodiment C2. The method of Example Embodiment C1, wherein performing the at least one action based on the information comprises: determining that the first UE is not performing data collection; and determining not to monitor a communication channel for the at least one reference signal.

Example Embodiment C3. The method of Example Embodiment C1, wherein performing the at least one action based on the information comprises: receiving the at least one reference signal intended for the second UE; and performing at least one measurement on the at least one reference signal; and storing the at least one measurement.

Example Embodiment C4. The method of Example Embodiment C3, comprising using the at least one measurement for a data collection purpose.

Example Embodiment C5. The method of any one of Example Embodiments C2 to C4, comprising using the at least one measurement to train an Artificial Intelligence (AI) and/or Machine Learning (ML) model.

Example Embodiment C6. The method of f Example Embodiment C5, comprising using the AI and/or ML model for beam management and/or beam prediction.

Example Embodiment C7. The method of any one of Example Embodiments C3 to C6, wherein the information comprises a data_collection_measurement-radio network temporary identifier (data_collection_measurement-RNTI), and the method comprises monitoring a physical downlink control channel associated with the data_collection_measurement-RNTI.

Example Embodiment C8. The method of any one of Example Embodiments C3 to C6, comprising: receiving a second message from the network node, the second message comprising a data_collection_measurement-radio network temporary identifier (data_collection_measurement-RNTI), and monitoring a physical downlink control channel associated with the data collection measurement-RNTI.

Example Embodiment C9. The method of Example Embodiment C8, wherein the data collection measurement-RNTI identifies a number of DL-reference signals in a number of beams to be transmitted to the second UE.

Example Embodiment C10. The method of any one of Example Embodiments C1 to C9, wherein the first message comprises a downlink (DL) reference signal (RS) configuration.

Example Embodiment C11. The method of Example Embodiment C10, wherein the DL RS configuration comprises at least one DL RS resource set.

Example Embodiment C12. The method of any one of Example Embodiments C1 to C11. wherein the first message comprises a network node configuration.

Example Embodiment C13. The method of Example Embodiment C12, wherein the network node beam configuration comprises at least one of: at least one beam identifier, at least one spatial correlation and/or QCL relation between beam identifiers, at least one spatial correlation and/or QCL relation between at least one beam identifier and at least one reference signal, and association between at least one beam identifier and a DL reference signal resource.

Example Embodiment C14. The method of any one of Example Embodiments C1 to C11, comprising receiving a third message from the network node, the third message comprising a network node beam configuration.

Example Embodiment C15.The method of Example Embodiment C14, wherein the network node beam configuration comprises at least one of: at least one beam identifier, at least one spatial correlation and/or QCL relation between beam identifiers, at least one spatial correlation and/or QCL relation between at least one beam identifier and at least one reference signal, and association between at least one beam identifier and a DL reference signal resource.

Example Embodiment C16. The method of any one of Example Embodiments C1 to C15,wherein at least one of the first, second, and third messages comprises a RRCReconfiguration message or a Medium Access Control-Control Element (MAC-CE).

Example Embodiment C17. The method of Example Embodiments C1 to C16, further comprising: providing user data; and forwarding the user data to a host via the transmission to the network node.

Example Embodiment C18. A user equipment comprising processing circuitry configured to perform any of the methods of Example Embodiments C1 to C17.

Example Embodiment C19. A wireless device comprising processing circuitry configured to perform any of the methods of Example Embodiments C1 to C17.

Example Embodiment C20. A computer program comprising instructions which when executed on a computer perform any of the methods of Example Embodiments C1 to C17.

Example Embodiment C21. A computer program product comprising computer program, the computer program comprising instructions which when executed on a computer perform any of the methods of Example Embodiments C1 to C17.

Example Embodiment C22. A non-transitory computer readable medium storing instructions which when executed by a computer perform any of the methods of Example Embodiments C1 to C17.

### Group D Example Embodiments

Example Embodiment D1. A method by a first user equipment (UE) for data collection, the method comprising: receiving, from a network node, a first message configuring at least one aperiodic downlink (DL) reference signal (RS) resource set; and receiving, from the network node, a second message comprising an indication to monitor a communication channel associated with a radio network temporary identifier (RNTI); receiving a third message comprising information associated with an RS to be transmitted for a second UE; based on the third message, receiving the RS to be transmitted for the second UE; and performing at least one measurement on the RS transmitted for the second UE.

Example Embodiment D2. The method of Example Embodiment D1, wherein the first message comprises a field for configuring the one or more aperiodic DL RS resource sets.

Example Embodiment D3. The method of Example Embodiment D2, wherein the field is a DL RS configuration field.

Example Embodiment D4. The method of any one of Example Embodiments D1 to D3, wherein the second message comprises a field containing the indication to monitor the communication channel.

Example Embodiment D5. The method of Example Embodiment D4, wherein the field comprises a Search space configuration field.

Example Embodiment D6. The method of any one of Example Embodiments D1 to D5, wherein the communication channel comprises a physical downlink control channel (PDCCH).

Example Embodiment D7. The method of any one of Example Embodiments D1 to D6, wherein a Cyclic Redundancy Check (CRC) is scrambled by the RNTI.

Example Embodiment D8. The method of any one of Example Embodiments D1 to D7, wherein the RNTI comprises a data_collection_measurement-RNTI.

Example Embodiment D9. The method of any one of Example Embodiments D1 to D8, wherein the third message comprises information indicating when to measure the communication channel for the RS to be transmitted for a second UE.

Example Embodiment D10a. The method of any one of Example Embodiments D1 to D9, comprising receiving a fourth message from the network node, the fourth message comprising a configuration associated with at least one beam identifier.

Example Embodiment D10b. The method of Example Embodiment D10a, wherein the configuration comprises a Network node beam configuration.

Example Embodiment D10c. The method of any one of Example Embodiments D10a to D10b, wherein the configuration comprises a list of beam identifiers.

Example Embodiment D10d. The method of Example Embodiment D10c, wherein the configuration comprises at least one spatial correlation and/or QCL relation for the beam identifiers.

Example Embodiment D10e. The method of Example Embodiment D10d, wherein each Beam identifier is associated with a DL-RS resource.

Example Embodiment D11. The method of any one of Example Embodiments D1 to D10e, wherein the first message comprises a DL reference signal configuration configuring the at least one aperiodic DL RS resource set.

Example Embodiment D12. The method of any one of Example Embodiments D1 to D11, wherein the RNTI indicates an aperiodic trigger state.

Example Embodiment D13. The method of Example Embodiment D12, comprising based on the aperiodic trigger state, ignoring or determining not to send a CSI report.

Example Embodiment D14. The method of any one of Example Embodiments D1 to D13, wherein a communication associated with the RNTI indicates at least one beam used by the network node when transmitting in the aperiodic DL RS resource set.

Example Embodiment D15. The method of Example Embodiment D14, wherein the at least one beam is associated with a set of Beam IDs.

Example Embodiment D16. The method of Example Embodiment D14, wherein the communication associated with the RNTI comprises at least one identifier of a corresponding at least one DL-RS resource, and wherein each DL-RS resource is associated with a beam.

Example Embodiment D17. The method of Example Embodiment D14, wherein the communication associated with the RNTI comprises an indication of an aperiodic trigger state, and wherein the at least one beam is configured for the aperiodic trigger state.

Example Embodiment D18. The method of Example Embodiment D17, wherein the at least one beam is configured for the aperiodic trigger state using at least one beam identifier.

Example Embodiment D19. The method of any one of Example Embodiments D1 to D18, wherein a QCL relation for at least one DL-RS resource is indicated in the communication channel associated with a RNTI.

Example Embodiment D20. The method of Example Embodiment D19, wherein the QCL relation is indicated with a list of TCI state identifiers.

Example Embodiment D21. The method of any one of Example Embodiments D1 to D20, wherein transmitting, to the network node, information indicating a capability of the first UE to support data collection for beam prediction based on the RS intended for another UE.

Example Embodiment D22. The method of Example Embodiments D1 to D21, further comprising: providing user data; and forwarding the user data to a host via the transmission to the network node.

Example Embodiment D23. A user equipment comprising processing circuitry configured to perform any of the methods of Example Embodiments D1 to D22.

Example Embodiment D24. A wireless device comprising processing circuitry configured to perform any of the methods of Example Embodiments D1 to D22.

Example Embodiment D25. A computer program comprising instructions which when executed on a computer perform any of the methods of Example Embodiments D1 to D22.

Example Embodiment D26. A computer program product comprising computer program, the computer program comprising instructions which when executed on a computer perform any of the methods of Example Embodiments D1 to D22.

Example Embodiment D27. A non-transitory computer readable medium storing instructions which when executed by a computer perform any of the methods of Example Embodiments D1 to D22.

### Group E Example Embodiments

Example Embodiment E1. A method by a network node for data collection, the method comprising: transmitting, to a first UE, a first message comprising information associated with at least one signal intended for transmission to a second UE; and transmitting, to the first UE, a second message comprising a data_collection_measurement-radio network temporary identifier (data_collection_measurement-RNTI) to trigger the first UE to monitor a physical downlink control channel associated with the data_collection_measurement-RNTI; and transmitting the at least one signal intended for the second UE.

Example Embodiment E2. The method of Example Embodiment E1, wherein the data collection measurement-RNTI identifies a number of DL-reference signals in a number of beams to be transmitted to the second UE.

Example Embodiment E3. The method of any one of Example Embodiments E1 to E2, wherein the first message comprises a downlink (DL) reference signal (RS) configuration, and wherein the DL RS configuration comprises at least one DL RS resource set.

Example Embodiment E4. The method of any one of Example Embodiments E1 to E2, wherein the first message comprises a network node configuration.

Example Embodiment E5. The method of Example Embodiment E4, wherein the network node beam configuration comprises at least one of: at least one beam identifier, at least one spatial correlation and/or QCL relation between beam identifiers, at least one spatial correlation and/or QCL relation between at least one beam identifier and at least one reference signal, and association between at least one beam identifier and a DL reference signal resource.

Example Embodiment E6. The method of any one of Example Embodiments E1 to E3, comprising transmitting, to the first UE, a third message comprising a network node beam configuration.

Example Embodiment E7. The method of Example Embodiment E6, wherein the network node beam configuration comprises at least one of: at least one beam identifier, at least one spatial correlation and/or QCL relation between beam identifiers, at least one spatial correlation and/or QCL relation between at least one beam identifier and at least one reference signal, and association between at least one beam identifier and a DL reference signal resource.

Example Embodiment E8. The method of any one of Example Embodiments E1 to E7, wherein at least one of the first, second, and third messages comprises a RRCReconfiguration message or a Medium Access Control-Control Element (MAC-CE).

Example Embodiment E9. The method of any one of Example Embodiments E1 to E8, wherein the network node comprises a gNodeB (gNB).

Example Embodiment E10. The method of any of Example Embodiments E1 to E9, further comprising: obtaining user data; and forwarding the user data to a host or a user equipment.

Example Embodiment E11. A network node comprising processing circuitry configured to perform any of the methods of Example Embodiments E1 to E10.

Example Embodiment E12. A computer program comprising instructions which when executed on a computer perform any of the methods of Example Embodiments E1 to E10.

Example Embodiment E13. A computer program product comprising computer program, the computer program comprising instructions which when executed on a computer perform any of the methods of Example Embodiments E1 to E10.

Example Embodiment E14. A non-transitory computer readable medium storing instructions which when executed by a computer perform any of the methods of Example Embodiments E1 to E10.

### Group F Example Embodiments

Example Embodiment F1. A method by a network node for data collection, the method comprising: transmitting, to a first UE, a first message configuring at least one aperiodic downlink (DL) reference signal (RS) resource set; and transmitting, to the first UE, a second message comprising an indication to monitor a communication channel associated with a radio network temporary identifier (RNTI); transmitting, to the first UE, a third message to trigger the first UE to monitor the communication channel associated with the data_collection_measurement-RNTI for an RS to be transmitted for a second UE; and transmitting the at least one signal intended for the second UE.

Example Embodiment F2. The method of Example Embodiment F1, wherein the first message comprises a field for configuring the one or more aperiodic DL RS resource sets.

Example Embodiment F3. The method of Example Embodiment F2, wherein the field is a DL RS configuration field.

Example Embodiment F4. The method of any one of Example Embodiments F1 to F3, wherein the second message comprises a field containing the indication to monitor the communication channel.

Example Embodiment F5. The method of Example Embodiment F4, wherein the field comprises a Search space configuration field.

Example Embodiment F6. The method of any one of Example Embodiments F1 to F5, wherein the communication channel comprises a physical downlink control channel (PDCCH).

Example Embodiment F7. The method of any one of Example Embodiments F1 to F6, wherein a Cyclic Redundancy Check (CRC) is scrambled by the RNTI.

Example Embodiment F8. The method of any one of Example Embodiments F1 to F7, wherein the RNTI comprises a data_collection_measurement-RNTI.

Example Embodiment F9. The method of any one of Example Embodiments F1 to F8, wherein the third message comprises information indicating when to measure the communication channel for the RS to be transmitted for a second UE.

Example Embodiment F10a. The method of any one of Example Embodiments F1 to F9, comprising transmitting, to the UE, a fourth message comprising a configuration associated with at least one beam identifier.

Example Embodiment F10b. The method of Example Embodiment F10a, wherein the configuration comprises a Network node beam configuration.

Example Embodiment F10c. The method of any one of Example Embodiments F10a to F10b, wherein the configuration comprises a list of beam identifiers.

Example Embodiment F10d. The method of Example Embodiment F10c, wherein the configuration comprises at least one spatial correlation and/or QCL relation for the beam identifiers.

Example Embodiment F10e. The method of Example Embodiment F10d, wherein each Beam identifier is associated with a DL-RS resource.

Example Embodiment F11. The method of any one of Example Embodiments F1 to F10e, wherein the first message comprises a DL reference signal configuration configuring the at least one aperiodic DL RS resource set.

Example Embodiment F12. The method of any one of Example Embodiments F1 to F11, wherein the RNTI indicates an aperiodic trigger state.

Example Embodiment F13. The method of Example Embodiment F12, comprising configuring the first UE to, based on the aperiodic trigger state, ignore or determine not to send a CSI report.

Example Embodiment F14. The method of any one of Example Embodiments F1 to F13, wherein a communication associated with the RNTI indicates at least one beam used by the network node when transmitting in the aperiodic DL RS resource set.

Example Embodiment F15. The method of Example Embodiment F14, wherein the at least one beam is associated with a set of Beam IDs.

Example Embodiment F16. The method of Example Embodiment F14, wherein the communication associated with the RNTI comprises at least one identifier of a corresponding at least one DL-RS resource, and wherein each DL-RS resource is associated with a beam.

Example Embodiment F17. The method of Example Embodiment F14, wherein the communication associated with the RNTI comprises an indication of an aperiodic trigger state, and wherein the at least one beam is configured for the aperiodic trigger state.

Example Embodiment F18. The method of Example Embodiment F17, wherein the at least one beam is configured for the aperiodic trigger state using at least one beam identifier.

Example Embodiment F19. The method of any one of Example Embodiments F1 to F18, wherein a QCL relation for at least one DL-RS resource is indicated in the communication channel associated with a RNTI.

Example Embodiment F20. The method of Example Embodiment F19, wherein the QCL relation is indicated with a list of TCI state identifiers.

Example Embodiment F21. The method of any one of Example Embodiments F1 to F20, wherein receiving, from the first UE, information indicating a capability of the first UE to support data collection for beam prediction based on the RS intended for another UE.

Example Embodiment F22. The method of Example Embodiments F1 to F21, further comprising: providing user data; and forwarding the user data to a host via the transmission to the network node.

Example Embodiment F23. A user equipment comprising processing circuitry configured to perform any of the methods of Example Embodiments F1 to F22.

Example Embodiment F24. A wireless device comprising processing circuitry configured to perform any of the methods of Example Embodiments F1 to F22.

Example Embodiment F25. A computer program comprising instructions which when executed on a computer perform any of the methods of Example Embodiments F1 to F22.

Example Embodiment F26. A computer program product comprising computer program, the computer program comprising instructions which when executed on a computer perform any of the methods of Example Embodiments F1 to F22.

Example Embodiment F27. A non-transitory computer readable medium storing instructions which when executed by a computer perform any of the methods of Example

Embodiments F1 to F22.

### Group G Example Embodiments

Example Embodiment G1. A user equipment (UE) for data collection, the UE comprising: processing circuitry configured to perform any of the steps of any of the Group A, C, and D Example Embodiments; and power supply circuitry configured to supply power to the processing circuitry

Example Embodiment G2. A network node for data collection, the network node comprising: processing circuitry configured to perform any of the steps of any of the Group B, E, and F Example Embodiments; power supply circuitry configured to supply power to the processing circuitry.

Example Embodiment G3. A user equipment (UE) for data collection, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A, C, and D Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment G4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, C, and D Example Embodiments to receive the user data from the host.

Example Embodiment G5. The host of the previous Example Embodiment, wherein the cellular network further includes a network node configured to communicate with the UE to transmit the user data to the UE from the host.

Example Embodiment G6. The host of the previous 2 Example Embodiments, wherein: the processing circuitry of the host is configured to execute a host application, thereby providing the user data: and the host application is configured to interact with a client application executing on the UE, the client application being associated with the host application.

Example Embodiment G7. A method implemented by a host operating in a communication system that further includes a network node and a user equipment (UE), the method comprising: providing user data for the UE: and initiating a transmission carrying the user data to the UE via a cellular network comprising the network node, wherein the UE performs any of the operations of any of the Group A embodiments to receive the user data from the host.

Example Embodiment G8. The method of the previous Example Embodiment, further comprising: at the host, executing a host application associated with a client application executing on the UE to receive the user data from the UE.

Example Embodiment G9. The method of the previous Example Embodiment, further comprising: at the host, transmitting input data to the client application executing on the UE, the input data being provided by executing the host application, wherein the user data is provided by the client application in response to the input data from the host application.

Example Embodiment G10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, C, and D Example Embodiments to transmit the user data to the host.

Example Embodiment G11. The host of the previous Example Embodiment, wherein the cellular network further includes a network node configured to communicate with the UE to transmit the user data from the UE to the host.

Example Embodiment G12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G13. A method implemented by a host configured to operate in a communication system that further includes a network node and a user equipment (UE), the method comprising: at the host, receiving user data transmitted to the host via the network node by the UE, wherein the UE performs any of the steps of any of the Group A, C, and D Example Embodiments to transmit the user data to the host.

Example Embodiment G14. The method of the previous Example Embodiment, further comprising: at the host, executing a host application associated with a client application executing on the UE to receive the user data from the UE.

Example Embodiment G15. The method of the previous Example Embodiment, further comprising: at the host, transmitting input data to the client application executing on the UE, the input data being provided by executing the host application, wherein the user data is provided by the client application in response to the input data from the host application.

Example Embodiment G16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, E, and F Example Embodiments to transmit the user data from the host to the UE.

Example Embodiment G17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment G18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, E, and F Example Embodiments to transmit the user data from the host to the UE.

Example Embodiment G19. The method of the previous Example Embodiment, further comprising, at the network node, transmitting the user data provided by the host for the UE.

Example Embodiment G20. The method of any of the previous 2 Example Embodiments, wherein the user data is provided at the host by executing a host application that interacts with a client application executing on the UE, the client application being associated with the host application.

Example Embodiment G21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, E, and F Example Embodiments to transmit the user data from the host to the UE.

Example Embodiment G22. The communication system of the previous Example Embodiment, further comprising: the network node; and/or the user equipment.

Example Embodiment G23. A host configured to operate in a communication system to provide an over-the-top (OTT) service, the host comprising: processing circuitry configured to initiate receipt of user data: and a network interface configured to receive the user data from a network node in a cellular network, the network node having a communication interface and processing circuitry, the processing circuitry of the network node configured to perform any of the operations of any of the Group B, E, and F Example Embodiments to receive the user data from a user equipment (UE) for the host.

Example Embodiment G24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G25. The host of the any of the previous 2 Example Embodiments, wherein the initiating receipt of the user data comprises requesting the user data.

Example Embodiment G26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, E, and F Example Embodiments to receive the 5 user data from the UE for the host.

Example Embodiment G27. The method of the previous Example Embodiment, further comprising at the network node, transmitting the received user data to the host.

1. A method by a first user equipment, UE, for data collection, the method comprising:
receiving, from a network node, a first message configuring one or more downlink reference signal resources;
receiving, from the network node, a second message comprising an indication to monitor a communication channel associated with a radio network temporary identifier, RNTI, for data collection;
receiving a third message comprising downlink control information, DCI, associated with the RNTI for data collection, where the third message indicates to the UE to perform measurements on the one or more of the downlink reference signal resources;
based on the third message comprising the DCI associated with the RNTI for data collection,
performing at least one measurement on a downlink reference signal transmitted for a second UE, where the downlink reference signal is transmitted on one of the one or more indicated downlink reference signal resources.

2. The method of claim 1, comprising using the at least one measurement to train an Artificial Intelligence, AI, and/or Machine Learning, ML, model.

3. The method of claim 2, comprising using the AI and/or ML model for beam management and/or beam prediction.

4. The method of claim 1, wherein the one or more downlink reference signal resources comprises one or more aperiodic downlink reference signal resources.

5. The method of claim 1, wherein the third message comprising the DCI indicates when to measure the communication channel for the reference signal to be transmitted for the second UE.

6. The method of claim 1, comprising receiving a network node beam configuration.

7. The method of claim 6, wherein the network node beam configuration comprises at least one of:
at least one beam identifier,
at least one spatial correlation and/or quasi co-located, QCL, relation between beam identifiers,
at least one spatial correlation and/or QCL relation between at least one beam identifier and at least one downlink reference signal resource, and
association between at least one beam identifier and a downlink reference signal resource.

8. The method of claim 7, wherein each beam identifier is associated with one resource within the one or more downlink reference signal resources.

9. The method of claim 6, wherein:
the network node beam configuration is received in the second message,
the network node beam configuration is received in the third message, or
the network node beam configuration is received in a fourth message.

10. The method of claim 1, wherein the RNTI indicates an aperiodic trigger state.

11. The method of claim 10, comprising, based on the aperiodic trigger state, ignoring or determining not to send a channel state information report.

12. The method of claim 1, wherein a quasi co-located, QCL, relation for at least one downlink reference signal resource is indicated in the communication channel associated with the RNTI.

13. The method of claim 12, wherein the QCL relation is indicated with a list of transmission configuration indicator, TCI, state identifiers.

14. The method of claim 1, comprising transmitting, to the network node, information indicating a capability of the first UE to support data collection for beam prediction based on the reference signal intended for the second UE.

15. A method by a network node for data collection, the method comprising:
transmitting, to a first user equipment, UE, a first message configuring one or more downlink reference signal resources;
transmitting, to the first UE, a second message comprising an indication to monitor a communication channel associated with a radio network temporary identifier, RNTI, for data collection:
transmitting, to the first UE, a third message comprising downlink control information, DCI, associated with the RNTI for data collection, the third message indicating to the first UE to perform measurements on the one or more downlink reference signal resources; and
based on the third message comprising the DCI associated with the RNTI for data collection, transmitting a reference signal to a second UE, where the reference signal is transmitted on one of the one or more indicated downlink reference signal resources.

16. The method of claim 15, comprising configuring the first UE to perform at least one measurement on the reference signal transmitted for the second UE.

17. The method of claim 15, comprising configuring the first UE to use the at least one measurement to train an Artificial Intelligence, AI, and/or Machine Learning, ML, model.

18. The method of claim 17, comprising using the AI and/or ML model for beam management and/or beam prediction.

19. The method of claim 15, wherein the one or more downlink reference signal resources comprises one or more aperiodic downlink reference signal resources.

20. The method of claim 15, wherein the third message comprising the DCI indicates when to measure the communication channel for the reference signal to be transmitted to the second UE.

21. The method of claim 15, comprising transmitting, to the first UE, a network node beam configuration.

22. The method of claim 21, wherein the network node beam configuration comprises at least one of:
at least one beam identifier,
at least one spatial correlation and/or quasi co-located, QCL, relation between beam identifiers,
at least one spatial correlation and/or QCL relation between at least one beam identifier and at least one reference signal, and
association between at least one beam identifier and a downlink reference signal resource.

23. The method of claim 22, wherein each beam identifier is associated with one of the one or more downlink reference signal resources.

24. The method of claim 21, wherein:
the network node beam configuration is transmitted in the second message,
the network node beam configuration is transmitted in the third message, or
the network node beam configuration is transmitted in a fourth message.

25.-29. (canceled)

30. A first user equipment, UE, for data collection, the first UE comprising processing circuitry adapted to:
receive, from a network node, a first message configuring one or more downlink reference signal resources;
receive, from the network node, a second message comprising an indication to monitor a communication channel associated with a radio network temporary identifier, RNTI, for data collection;
receive a third message comprising downlink control information, DCI, associated with the RNTI for data collection, where the third message indicates to the UE to perform measurements on one or more of the downlink reference signal resources;
based on the third message comprising the DCI associated with the RNTI for data collection, perform at least one measurement on a downlink reference signal transmitted for a second UE, where the downlink reference signal is transmitted on one of the one or more indicated downlink reference signal resources.

31.-37. (canceled)

38. A network node for data collection, the network node adapted to:
transmit, to a first user equipment, UE, a first message configuring one or more downlink reference signal resources;
transmit, to the first UE, a second message comprising an indication to monitor a communication channel associated with a radio network temporary identifier, RNTI, for data collection;
transmit, to the first UE, a third message comprising downlink control information, DCI, associated with the RNTI for data collection; and
based on the third message comprising the DCI associated with the RNTI for data collection, transmit a reference signal to a second UE, where the reference signal is transmitted on one of the one or more indicated downlink reference signal resources.

39.-44. (canceled)
